(19) United States
(12) Patent Application Publication
(10) Pub. No.: US 2022/0231381 A1
(43) Pub. Date: Jul. 21, 2022

(54) Structural busbar for battery

(71) Applicant: Damon Motors Inc., Vancouver (CA)

(72) Inventors: Brian Ford, Petaluma, CA (US); Derek Dorresteyn, Mill Valley, CA (US)

(21) Appl. No.: 17/216,086

(22) Filed: Mar. 29, 2021

Related U.S. Application Data
(60) Provisional application No. 63/139,745, filed on Jan. 20, 2021.

(51) Int. Cl. H01M 50/503; H02G 5/02; H01M 10/613; H01M 10/6554; H01M 50/507

(52) U.S. Cl. CPC H01M 50/503; H02G 5/02; H01M 50/507; H01M 10/6554; H01M 10/613

(57) ABSTRACT

The busbar has a planar portion and multiple blisters that project from it. The blisters have a beam-like structure and provide structural rigidity to the busbar. When the ends of the blisters are connected to the terminals of the cells in the battery, the battery assembly is provided with structural strength. The busbars may be arranged side-by-side or in layers. When in layers, the blisters of upper busbars project through holes in lower busbars. Busbar assemblies may include insulating spacers, insulating layers or venting features. By using the busbar as a structural member, the required strength and weight of the remaining components of the battery pack are reduced.

### TECHNICAL FIELD

The invention relates to busbars. In particular, the invention relates to busbars for batteries, busbar assemblies for batteries and batteries made with the busbars.

### BACKGROUND

Advances in technology and an increasing desire to reduce damage to the environment have led to the more widespread adoption of electric vehicles. Electric cells for electric vehicles are usually grouped together in battery packs. The battery packs need to have sufficient strength to safely contain the cells while allowing electrical connections to them for drawing power and recharging. Due to the number of cells required, electrical vehicles can be considerably heavier than comparable gasoline powered vehicles.

This background is not intended, nor should be construed, to constitute prior art against the present invention.

### SUMMARY

A busbar provides electrical connection to a plurality of cells in a battery. The busbar also provides mechanical strength to the structure of the battery pack. The mechanical strength provided to the battery pack is sufficient so that the remainder of the battery pack does not need to be as mechanically strong or as heavy as it would need to be if the busbar were a mere electrical connection. By using the busbar as a structural element, there may also be a reduction in the number of components required, such as fasteners, and a corresponding reduction in complexity.

The busbar's mechanical strength is provided by blisters or other equivalent structures projecting from a plate-like body of the busbar. The outermost ends of the blisters are welded to the terminals of the cells. The configuration of the busbar provides a convenient arrangement for the welding process, and contributes to a robust battery pack. The busbar may be used in a battery pack for a vehicle such as a motorcycle, for example.

Disclosed herein is a structural busbar for a battery comprising a metal plate and a plurality of blisters projecting from the metal plate.

Also disclosed is a structural busbar assembly for a battery comprising: a first structural busbar comprising a first metal plate and a plurality of first blisters projecting from the first metal plate; a second structural busbar comprising a second metal plate and a plurality of second blisters projecting from the second metal plate; and an insulating spacer between the first and second structural busbars; wherein each of the first and second blisters is spot-weldable to a different electrical terminal of a cell of the battery.

Further disclosed is a battery comprising: multiple cells; a battery case holding the cells in an array; a cooling plate to which the cells are glued; a battery case cap defining holes that are located to expose each cell's electrical terminals; an insulating layer positioned over and spaced apart from the battery case cap, the insulating layer defining holes that provide access to the electrical terminals; a first structural busbar comprising a first metal plate and a plurality of first blisters projecting perpendicularly from one side of the first metal plate, wherein the first structural busbar is positioned over the insulating layer, the first blisters project through the insulating layer and are welded to the electrical terminals having a first polarity, and the first metal plate defines holes that expose the electrical terminals having a second polarity; an insulating spacer positioned over the first structural busbar and defining holes that expose the electrical terminals of a second polarity and a recess behind each first blister; a second structural busbar comprising a second metal plate and a plurality of second blisters projecting perpendicularly from one side of the second metal plate, wherein the second structural busbar is positioned over the insulating spacer, the second blisters project through the insulating spacer, the first metal plate and the insulating layer, and are welded to the electrical terminals of the second polarity, and the second metal plate defines holes that expose a recess behind each first blister; and a collector cap with vent holes positioned over the second structural busbar; wherein the battery case, the battery case cap, the insulating layer, the first structural busbar, the insulating spacer, the second structural busbar, and the collector cap are fastened to the cooling plate.

### BRIEF DESCRIPTION OF DRAWINGS

FIG. 1 is a cut-away perspective view of two structural busbars connected to a battery, according to an embodiment of the present invention.

FIG. 2 is a perspective view of the two structural busbars connected to a battery, according to an embodiment of the present invention.

FIG. 3 is a perspective view of a structural busbar showing the blisters, according to an embodiment of the present invention.

FIG. 4 is a perspective view of a structural busbar showing the recesses that are on the reverse side of the blisters, according to an embodiment of the present invention.

FIG. 5 is an exploded view of a battery pack with structural busbars, according to an embodiment of the present invention.

FIG. 6 is another exploded view of a battery pack with structural busbars, according to an embodiment of the present invention.

FIG. 7 is a portion of a circuit diagram showing connections of the structural busbar portions, according to an embodiment of the present invention.

FIG. 8 is schematic exploded view of a battery pack with structural busbars, according to an embodiment of the present invention.

FIG. 9 is another exploded view of a battery pack with structural busbars, according to an embodiment of the present invention.

FIG. 10 is a side cut-away view showing the connections between the structural busbars and the cells, according to an embodiment of the present invention.

### DETAILED DESCRIPTION

### A. Glossary

Busbar—this refers to a metallic strip, spider, plate or other structure, which is used as an electrical conductor for multiple components. Usually, a busbar is a single piece of metal.

Structural busbar—this refers to a busbar that provides mechanical rigidity or strength to an assembly of which it is part. This is achieved by using, for example, thicker materials than are necessary for achieving a suitable electrical connection. It may also be achieved by incorporating structural features in the busbar.

Cell or electrical cell—this refers to a device capable of generating electricity from a chemical reaction. A cell typically has one positive terminal and one negative terminal. Cells may be rechargeable.

Collector—a form of busbar that connects to the terminals of one or more cells.

### B. Exemplary Embodiments

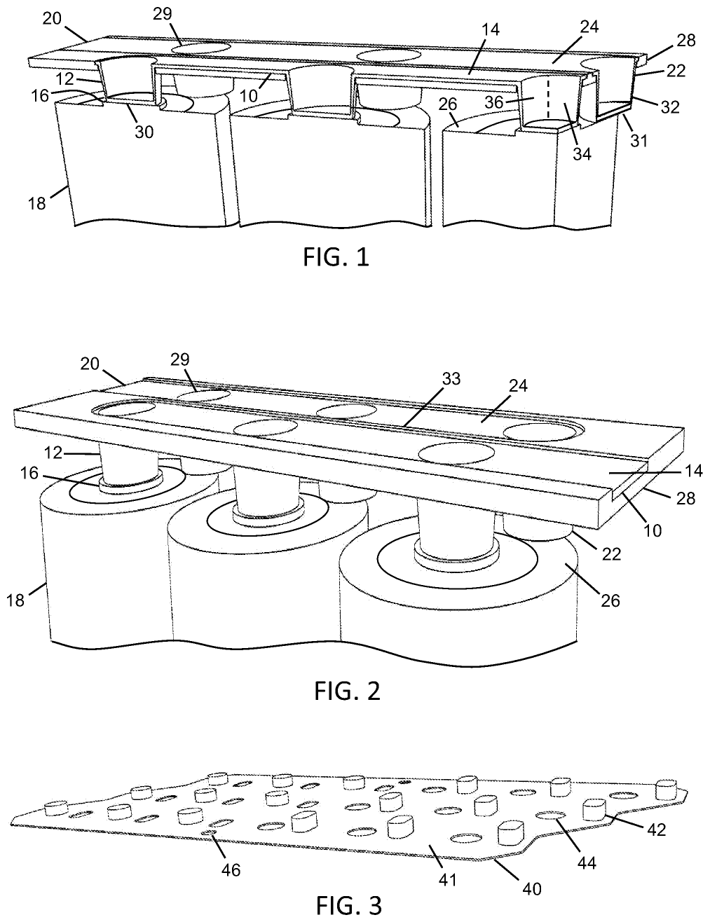

Referring to FIGS. 1 and 2, where FIG. 1 is a cut-away of FIG. 2, exemplary structural busbars 10 and 20 are shown. The structural busbar 10 has blisters 12 projecting outwards from plate 14 of the structural busbar 10. The blisters 12 are beam-like elements with ends 30. The blisters 12 are connected via their ends 30 to the positive terminals 16 of the cells 18. Connections of the blisters 12 to the positive terminals 16 are spot-welds or laser spot-welds, for example. Structural busbar 20 has blisters 22 projecting outwards from plate 24 of the structural busbar 20. The blisters 22 are connected via their ends 31 to the negative terminals 26 of the cells 18. Connections of the blisters 12 to the negative terminals 18 are spot-welds or laser spot-welds, for example. The structural busbars 10, 20 are held apart from each other by an insulating spacer 28 or structural busbar holder that has a portion 33 that lies between the structural busbars.

The blisters 12, 22 may project perpendicularly from the plates 14, 24 of the structural busbars 10, 20. That is, the axes of the beam-like portions of the blisters 12, 22 are perpendicular to the plates 14, 24. However, the wall 32 or walls of the blisters may or may not be perpendicular to the bodies. In this example, the walls 32 are inclined or tapered, to form a frustum of a cone, and the blisters 12, 22 are therefore cup-shaped. The beam-like structure of the blisters 12, 22 provides strength to the structural busbars 10, 20. In particular, the strength or stiffness is at least in part due to the blister 12, 22 having at least two non-parallel walls, or two portions 34, 36 of the wall 32 that are non-coplanar or non-parallel. As at least two portions 34, 36 of the wall 32 are non-parallel, the blisters 12, 22 act as structural beams, cantilevered from the plates 14, 24 of the structural busbars 10, 20.

The formation of ends 30, 31 on the blisters 12, 22 at the extremities of the non-coplanar walls or wall portions 34, 36 add stiffness to the structural busbars 10, 20 in particular at the area of the weld. The weld is between the ends 30, 31 and the cells 18. In the example shown, the geometry of the structural busbars 10, 20 presents a weld area at the base of the recess 29 that is not occluded or otherwise interfered with. Having stiffness in the structural busbar 10, 20 near the weld area allows for a fixturing force near the weld area, while allowing for the structural busbar plate 14, 24, which is in a plane offset from the ends 30, 31, to deflect and compensate for any gaps at the weld sites between the blisters 12, 22 and the cells 18. This applies at the positive terminal 16 at the cap location and the negative terminal 26 at the perimeter crimp location.

The reverse sides of the structural busbars 10, 20 to the blisters 12, 22 have recesses 29 corresponding to the hollow interiors of the blisters as a result of their manufacture. The structural busbars 10, 20 are made by forming, for example. Blisters 12, 22 may be hydraulically or mechanically formed in metal plates. As there is usually a limit to the depth of offset features such as the blisters 12, 22, they may need to be drawn in multiple steps, taking into consideration the plate thickness, the wall thickness and the properties of the plate material. After drawing, the metal plates are then blanked into individual structural busbars 10, 20 by laser or water jet cutting. As one of skill in the art would appreciate, other techniques may be employed to manufacture the structural busbars 10, 20.

The structural busbars 10, 20 may be made from copper, for example, for its electrical and thermal conductivity. The structural busbars 10, 20 may also be made from any other suitable metal such as aluminum, aluminum alloys, copper alloys, silver, etc. The cans and positive terminals of the cells may be steel, for example. The thicknesses of the ends 30, 31 of the blisters 12, 22 may be, for example, 0.3 mm or less, which tends to be more suitable for laser spot welding. In other embodiments, thicker ends 30, 31 may be employed. In these cases, central regions of the ends 30, 31 may be thinned by a coining process prior to laser spot welding. The plates 14, 24 of the structural busbars 10, 20 may be the same thickness or a greater thickness than the ends 30, 31 of the blisters 12, 22.

In this example, three cells 18 are connected in parallel to the structural busbars 10, 20. However, in other embodiments, any number of two or more cells may be connected. Series, parallel and combinations of series and parallel connections may be used. For example, there may be 36 cells connected with the busbars in series-parallel, or over 120 cells connected in parallel.

As it can be seen, the structural busbars 10, 20 provide structural elements for securing one end (the top end) of an array of cells 18. The blisters 12, 22 (or other equivalent connecting elements) also provide clearance between the plates 14, 24, which are the main conducting portions of the structural busbars 10, 20, and the tops of the cells 18.

It is evident that other shapes of the structural busbars 10, 20 are possible in other embodiments, and also that other shapes of the insulating spacer 28 are possible.

Referring to FIG. 3, a structural busbar 40 (or collector) is shown. Structural busbar 40 has a plate 41, which may be considered to be the body of the structural busbar. The side of the structural busbar 40 that connects to the cells is facing upwards, showing the blisters 42. Also defined in the plate 41 of the structural busbar are holes 44, which allow blisters of a similar structural busbar to project through and connect to different terminals of the cells than the blisters 42. The plate 41 also defines fixing holes 46, which permit the passage of screws, for example, to fasten two structural busbars and an intervening insulating spacer together onto a battery holder or case.

The shapes of the blisters may be circular, square with rounded corners, or rectangular with rounded corners, and different shapes may be used in the same busbar. For example, circular blisters may be used for connection to the positive terminals of the cells and rectangular blisters may be used for connection to the negative terminals of the busbars.

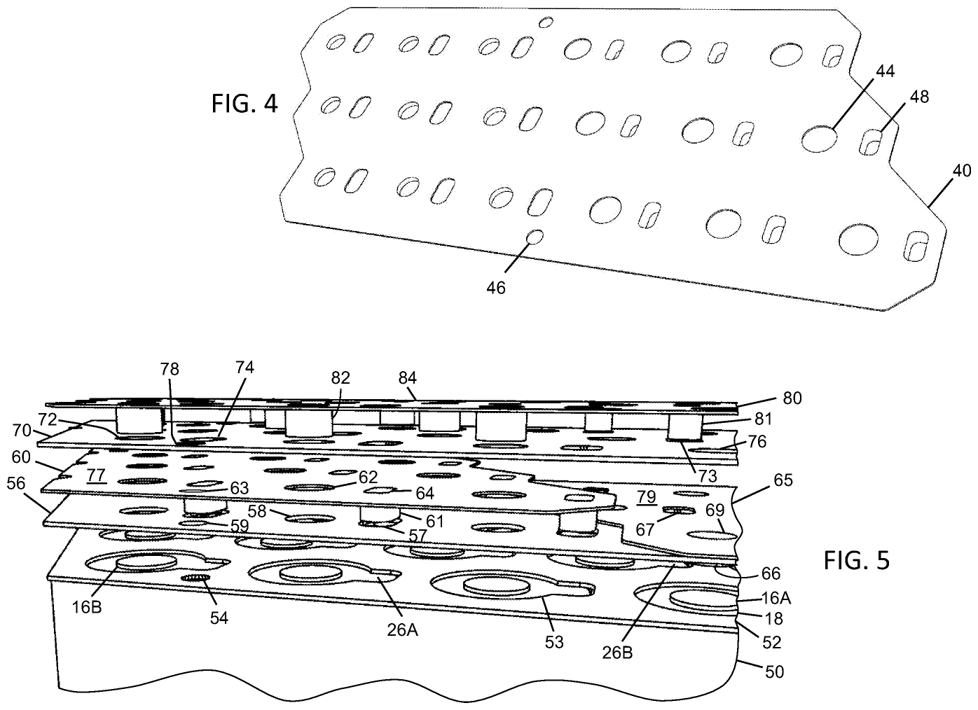

FIG. 4 shows the reverse side of busbar 40, showing the holes 44 for accommodating other blisters, fixing holes 46 and recesses 48 inside the blisters.

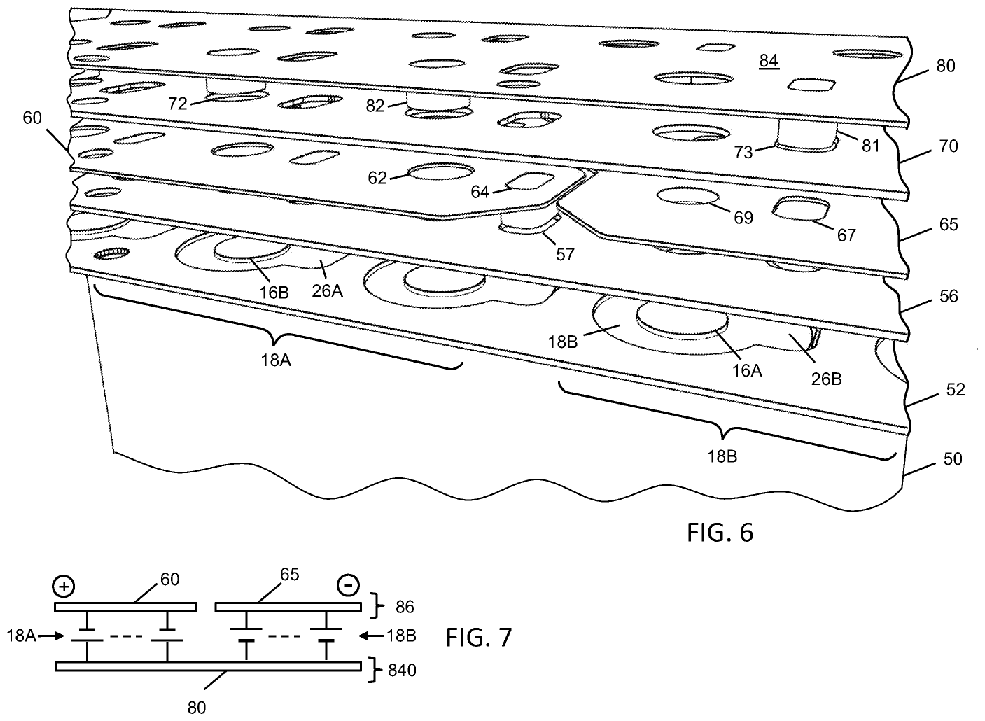

Referring to FIGS. 5 and 6, exploded views of a battery pack are shown. The cells 18 are housed in a battery case 50. An electrically insulating battery case cap 52 is placed over the cells 18 and case 50, and may be attached thereto by one or more screws in holes 54, for example. The battery case cap 52 has keyhole-shaped cap holes 53 in it that provide access to the positive terminals 16A, 16B and negative terminals 26A, 26B of the cells 18.

An insulating layer 56 is placed over the battery case cap 52, but is spaced apart from it by standoffs, for example, or stepped standoffs that locate the insulating layer 56 as well as maintaining its distance from the battery case cap 52. Ensuring alignment in X&Y and also height can be critical to weld success, as the welding process requires a high degree of positioning accuracy due to the fact that the target zone on the rim of the cell is small. The geometry of the standoff may be different on other embodiments, but the essential nature of its purpose is the same.

There are holes 57 defined in the insulating layer 56 to allow blisters 61, 81 on busbars 60, 80 to pass through for connection to the cells 18. There are holes 58 defined in the insulating layer 56 to allow blisters 66, 82 on busbars 65, 80 to pass through for connection to the cells 18. Fixing holes 59 are present in the insulating layer 56, which align with the holes 54 in the battery case cap 52.

Above the insulating layer 56 are two structural busbars 60, 65 (or collectors). Structural busbar 60 has blisters 61 projecting downwards through holes 57 for connection to the negative terminals 26A of some of the cells 18. Blisters 61 and holes 57 are therefore aligned with regions on the negative terminals 26A of the cells 18. Recesses 64 correspond to the insides of the blisters 61. Also present in structural busbar 60 are holes 62 that allow blisters 82 to pass through from a structural busbar 80 above. Fixing holes 63 are present in the structural busbar 60, which align with fixing holes 59, 54 in the insulating layer 56 and battery case cap 52 respectively.

Structural busbar 65 has blisters 66 projecting downwards through holes 58 for connection to the positive terminals 16A of some of the cells 18. Blisters 66 and holes 58 are therefore aligned with the positive terminals 16A of the cells 18. Blisters 66 extend from plate 79 of the structural busbar 65 less than blisters 61 extend from plate 77 of structural busbar 60, due to the difference in height between the positive terminals 16A and negative terminals 26A. Recesses 69 correspond to the insides of the blisters 66. Also present in structural busbar 65 are holes 67 that allow blisters 81 to pass through from a structural busbar 80 above. Fixing holes (not visible) are also present in the structural busbar 65, which align with other fixing holes in the insulating layer 56 and battery case cap 52 respectively. Structural busbars 60, 65 may be considered to form the bottom layer of structural busbars.

Above the bottom layer of structural busbars 60, 65 is an insulating spacer 70. There are holes 72 in the insulating spacer 70 that allow blisters 82 from structural busbar 80 to pass through for connection to the positive terminals 16B of some of the cells 18. There are also holes 73 in the insulating spacer 70 that allow blisters 81 from structural busbar 80 to pass through for connection to the negative terminals 26B of some of the cells 18. Also present in the insulating spacer 70 are further holes 74, which allow access to the recesses 64 for welding the blisters 61 to the negative terminals 26A. Likewise, holes 76 in the insulating spacer 70, which align with holes in the structural busbar 80, allow access to the recesses 69 for welding the blisters 66 to the positive terminals 16A. Fixing holes 78 are aligned with fixing holes 63, 59, 54 in the structural busbar 60, the insulating layer 56 and the battery case cap 52 respectively.

Structural busbar 80 is placed above the upper insulating spacer 70. Blisters 81 pass through holes 73 in the intervening insulating spacer 70, holes 67 in the structural busbar 65 and holes 57 in the lower insulating layer 56 to connect to the negative terminals 26B of some of the cells 18. Blisters 82 pass through holes 72 in the intervening insulating spacer 70, holes 62 in the structural busbar 60 and holes 58 in the insulating layer 56 to connect to the positive terminals 16B of some of the cells 18. The blisters 81, 82 extend further from the plate 84 of structural busbar 80 than the blisters 61, 66 from the plates 77, 79 of the structural busbars 60, 65. The blisters 81, 82 extend further because they need to pass through more layers (insulating spacer 70 and structural busbar 60 or 65) in order to reach the terminals of the cells 18. Blisters 61, 81 pass through the battery case cap 52 to reach the negative terminals 26A, 26B. Depending on the relative thickness of the battery case cap 52 to the height of the positive terminals 16B, 16A, the blisters 66, 82 may or may not pass through the battery case cap to reach the positive terminals.

FIG. 6 is an alternate view of the battery pack shown in FIG. 5. Structural busbars 60, 65, which form the lower structural busbar layer, are shown on the same level. The different shapes of the blisters 81, 82 in structural busbar 80 are more clearly discernable. Also, the different shapes of the various holes are more clearly visible.

Referring to FIG. 7, a circuit diagram of the structural busbars 60, 65, 80 is shown. Structural busbar 60 is connected to the negative terminals 26A of cells 18A. Structural busbar 80 is connected to the positive terminals 16A of cells 18A. The group of cells 18A are therefore connected in parallel. Structural busbar 80 is also connected to the negative terminals 26B of cells 18B. Structural busbar 65 is connected to the positive terminals 16B of cells 18B. The group of cells 18B are therefore also connected in parallel, and the two parallel groups of cells 18A, 18B are connected in series.

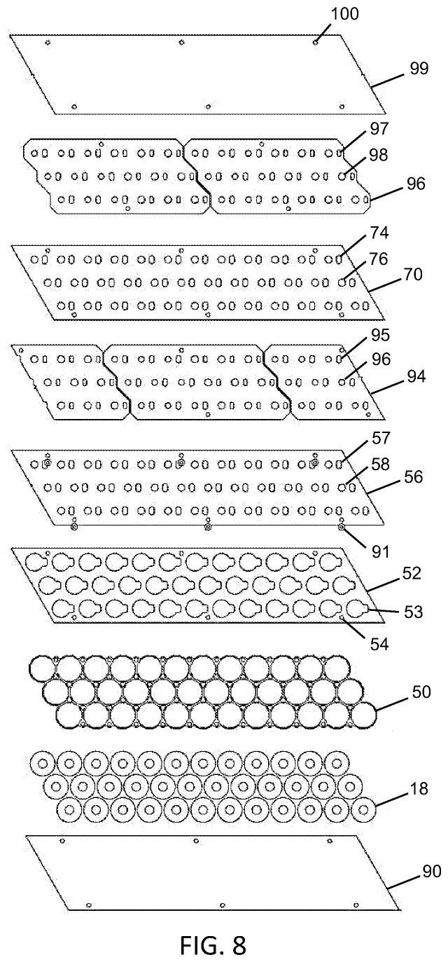

FIG. 8 is a view of the separate components of a battery pack that incorporates structural busbars. At the bottom, there is a cold plate 90. The cells 18 are glued, for example with epoxy, to the cold plate 90. The cold plate 90 therefore secures, at least in part, the bottom ends of the cells 18, i.e. the ends opposite to the ends that are welded to the structural busbars. The cold plate 90 serves to draw heat from the cells 18 during charging or discharging so that they remain at a safe operating temperature.

The battery case 50 (or fixturing platen) is placed around the cells 18, and serves to locate the cells in a uniform array while they are being glued to the cold plate 90. The array may be a honeycomb array, for example. The battery case 50 also serves to protect the sides of the cells against possible damaging exposure to the environment. The battery case 50 may be made from plastic, for example, so that its weight is low. The honeycomb structure (or other array structure) of the battery case 50 provides it with structural rigidity, which contributes to the overall structural strength of the battery pack.

Above the battery case 50, the battery case cap 52 is shown, with the keyhole-shaped cap holes 53 that provide access to the electrical terminals of the cells 18.

Above the battery case cap 52 is the insulating layer 56 with its holes 57, 58 for providing access to the negative and positive terminals respectively of the cells 18. Spacers 91 (e.g. bushes or standoffs) are shown that maintain the insulating layer 56 apart from the upper surface of the battery case cap 52. The insulating layer 56 is held adjacent to the lower surface of the structural busbar(s) above it.

Above the insulating layer 56 is the lower layer of structural busbars 94, which may include, for example, structural busbars 60, 65 (FIG. 5). As it will be appreciated, the number of structural busbars in layer 94 may be one or more depending on the embodiment. In this embodiment, there are three structural busbars that are electrically isolated from each other. Each detail 95, 96 in the structural busbar layer 94 corresponds to either a recess of a blister or a hole, depending on the embodiment.

The upper insulating spacer 70 is shown above the lower layer of structural busbars 94. The upper insulating spacer 70 has holes 74, 76 for providing access to the negative and positive terminals respectively of the cells 18, or to corresponding recesses in the lower layer of structural busbars 94, depending on the embodiment.

An upper layer of structural busbars 96 is shown. In this embodiment, there are two structural busbars that are electrically isolated from each other. Each detail 97, 98 in the structural busbar layer 96 corresponds to either a recess of a blister or a hole, depending on the embodiment.

On top is a collector cap 99, which insulates the upper structural busbar layer 96 and provides touch protection. The collector cap 99 may have hanging sidewalls that include venting pathways to allow hot gases that may escape through the tops of the cells 18 to disperse. The gases exit the cells and pass between the battery case cap 52 and the insulating layer 56.

Fixing holes 54 in all the various components allow the components to be fastened together to form the battery pack. Other fixing means are possible on other embodiments. For example, the battery case cap 52 may have press-studs that project downwards from its lower surface, and that can be pressed into receiving holes in the top of the battery case 50, which are located between the larger holes for the cells.

A potential benefit with using the structural busbars may occur during assembly, particularly if the case 50 has through-holes that loosely accommodate the cells. If the cells are picked and placed into the case 50, the battery case cap 52 is pressed into place and the lower layer of structural busbars 94 welded, then the busbars now secure all of the cells so that when the assembly is lifted by the case 50 to be moved to the next process, the cells do not fall out of the bottom of the case. This may be important in situations where the cells are not press-fitted into the case 50, as may occur using a pick-and-place robot needs some clearance to place the cells rapidly.

The insulating layer 56 that is immediately below the first current collector layer (structural busbars 94) may represent the bottom of a thermally sealed assembly that includes a stack of three insulating layers (56, 70, 99) and two intervening copper layers (94, 96).

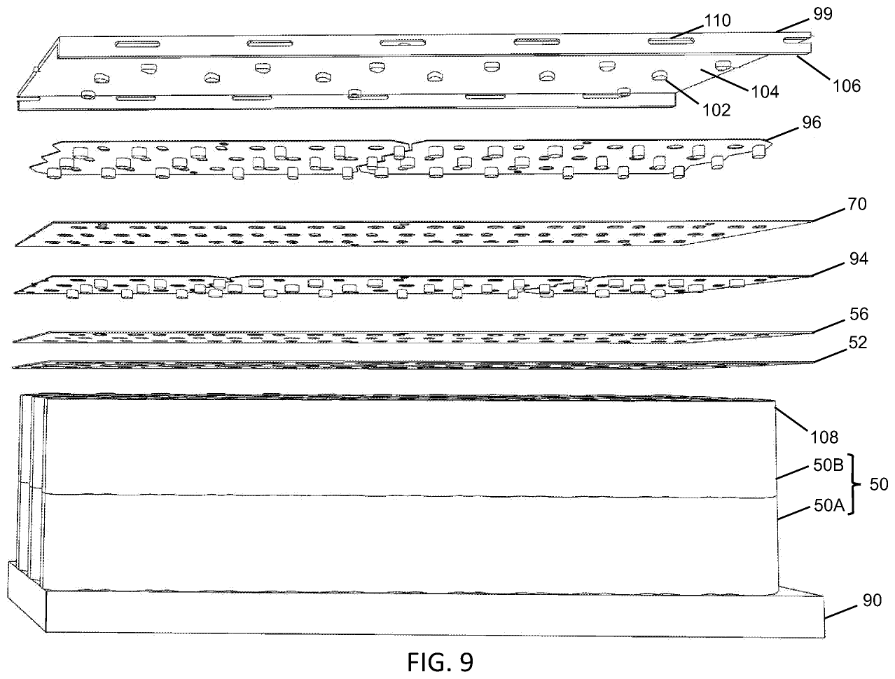

Referring to FIG. 9, another view is shown of the various components making up the battery pack. The battery case 50 is shown mounted on the cold plate 90. The battery case 50 may be split into a bottom part 50A and a top part 50B. Above the battery case 50 is the battery case cap 52, followed by the lower insulating layer 56, the lower layer of structural busbars 94, the upper insulating spacer 70 and the upper layer of structural busbars 96. On top is the collector cap 99, showing bosses 102 that extend downwards from a lower surface thereof. The bosses hold the planar portion 104 of the collector cap apart from the upper surface of the upper layer of structural busbars 96. This allows gases, which may be generated by the cells 18 and pass upwards through gaps in the layers of the assembly, to readily escape from the battery pack. The sidewalls 106 of the collector cap 99 project downwards over the edges of one or more of the lower layers. For example, the sidewalls 106 may project downwards to cover the edges of the lower insulating layer 56, or further downwards to overlap the upper region 108 of the battery case 50. The sidewalls 106 have vent holes 110 that allow the hot gases that may be generated by the cells 18 to escape from the battery pack.

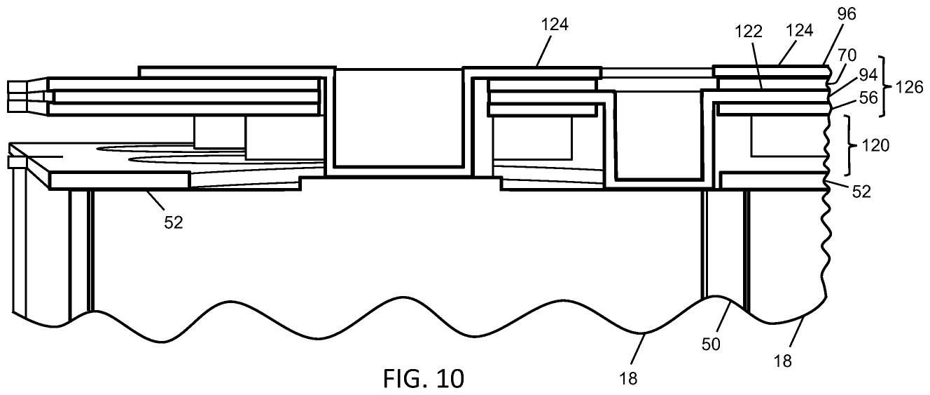

FIG. 10 is a side view showing the relative positioning of the layers in the battery pack. The battery case cap 52 is placed directly above the cells 18 and battery case 50. Between the battery case cap 52 and the lower insulating layer 56 there is a gap 120. The insulating layer 56, the plate 122 of the lower structural busbar layer 94, the insulating spacer 70 and the plate 124 of the upper structural busbar layer 96 form a sandwich arrangement 126. That is, these layers 56, 122, 70, 124 are stacked, with adjacent members of the stack being in contact with each other.

### C. Variations

Where the connecting elements between the busbars 10, 12 and the cells 18 have been described as blisters 12, 22, it is recognized that other shapes are possible in other embodiments. For example, the connecting elements may be tabs that are offset from the plates 14, 24 of the structural busbars 10, 20. The formation of the tabs may leave holes in the structural busbar plates 14, 24. The main requirement is that the tabs have a beam-like structure that provides structural rigidity to the tabs in relation to the plates 14, 24 of the structural busbar 10, 20. The beam-like structure may be provided by, for example, non-coplanar panels in each tab.

Individual holes shown in the components may be combined into larger holes in some embodiments. In other embodiments, holes may be subdivided into smaller holes. Additional holes may be present in the various layers of the structural busbar assembly in order to increase the venting capability of the battery pack. Some components in some embodiments may be omitted to provide other embodiments of the structural busbar, the structural busbar assembly and a battery pack incorporating the structural busbars.

In general, unless otherwise indicated, singular elements in one embodiment may be in the plural in other embodiments, and vice versa with no loss of generality.

Throughout the description, specific details have been set forth in order to provide a more thorough understanding of the invention. However, the invention may be practiced without these particulars. In other instances, well known elements have not been shown or described in detail and repetitions of steps and features have been omitted to avoid unnecessarily obscuring the invention. Accordingly, the specification is to be regarded in an illustrative, rather than a restrictive, sense.

It will be clear to one having skill in the art that further variations to the specific details disclosed herein can be made, resulting in other embodiments that are within the scope of the invention disclosed. All parameters, dimensions, materials, proportions and configurations described herein are examples only and actual values of such depend on the specific embodiment. Accordingly, the scope of the invention is to be construed in accordance with the substance defined by the following claims.

1. A structural busbar for a battery comprising:
a metal plate; and
a plurality of blisters projecting from the metal plate;
wherein the metal plate defines holes that are dimensioned to accommodate further blisters on a further structural busbar.

2. The structural busbar of claim 1, wherein each blister is spot-weldable to an electrical terminal of a cell of the battery.

3. The structural busbar of claim 1, wherein the blisters project perpendicularly from only one side of the metal plate.

4. The structural busbar of claim 1, wherein the blisters are cup-shaped.

5. The structural busbar of claim 1, wherein each blister comprises:
a beam-like element; and
an end connected to the beam-like element.

6. The structural busbar of claim 5, wherein each beam-like element comprises:
a wall having first and second portions that project from the metal plate, wherein the first and second portions of the wall are non-parallel; or
a first wall and a second wall, which is non-parallel with the first wall; or
a curved wall.

7. The structural busbar of claim 5, wherein each end is parallel to the metal plate.

8. The structural busbar of claim 5, wherein each end is coined.

9. The structural busbar of claim 1, wherein the blisters comprise a first type of blister and a second type of blister, wherein the second type of blister projects further from the metal plate than the first type of blister.

10. (canceled)

11. A structural busbar assembly for a battery comprising:
a first structural busbar comprising a first metal plate and a plurality of first blisters projecting from the first metal plate;
a second structural busbar comprising a second metal plate and a plurality of second blisters projecting from the second metal plate; and
an insulating spacer between the first and second structural busbars;
wherein each of the first and second blisters is spot-weldable to a different electrical terminal of a cell of the battery.

12. The structural busbar assembly of claim 11, wherein:
the first blisters project perpendicularly from one side of the first metal plate;
the second blisters project perpendicularly from one side of the second metal plate;
each of the first and second blisters comprises a beam-like element and an end connected to the beam-like element; and
the ends, first metal plates and second metal plates are parallel.

13. The structural busbar assembly of claim 12, comprising:
a battery case cap defining holes that are located to expose the electrical terminals; and
an insulating layer positioned over and spaced apart from the battery case cap, the insulating layer defining holes that provide access to the electrical terminals;
wherein:
the first structural busbar is positioned over the insulating layer;
the first blisters project through the insulating layer, for welding to the electrical terminals having a first polarity;
the first metal plate defines holes that expose the electrical terminals having a second polarity;
the insulating spacer is positioned over the first structural busbar, the insulating spacer defining holes that expose a recess behind each first blister and the electrical terminals of the second polarity;
the second structural busbar is positioned over the insulating spacer;
the second blisters project through the insulating spacer, the first metal plate and the insulating layer, for welding to the electrical terminals of the second polarity; and
the second metal plate defines holes that expose a recess behind each first blister.

14. The structural busbar assembly of claim 13, comprising a collector cap with vent holes positioned over the second structural busbar.

15. A battery comprising:
multiple cells;
a battery case holding the cells in an array;
a cooling plate to which the cells are glued;
a battery case cap defining holes that are located to expose each cell's electrical terminals;
an insulating layer positioned over and spaced apart from the battery case cap, the insulating layer defining holes that provide access to the electrical terminals;
a first structural busbar comprising a first metal plate and a plurality of first blisters projecting perpendicularly from one side of the first metal plate, wherein:
the first structural busbar is positioned over the insulating layer;
the first blisters project through the insulating layer and are welded to the electrical terminals having a first polarity; and
the first metal plate defines holes that expose the electrical terminals having a second polarity;
an insulating spacer positioned over the first structural busbar and defining holes that expose the electrical terminals of a second polarity and a recess behind each first blister;
a second structural busbar comprising a second metal plate and a plurality of second blisters projecting perpendicularly from one side of the second metal plate, wherein:
the second structural busbar is positioned over the insulating spacer;
the second blisters project through the insulating spacer, the first metal plate and the insulating layer, and are welded to the electrical terminals of the second polarity; and
the second metal plate defines holes that expose a recess behind each first blister; and
a collector cap with vent holes positioned over the second structural busbar;
wherein the battery case, the battery case cap, the insulating layer, the first structural busbar, the insulating spacer, the second structural busbar, and the collector cap are fastened to the cooling plate.
